(19) United States
(12) Patent Application Publication
(10) Pub. No.: US 2007/0000090 A1
(43) Pub. Date: Jan. 4, 2007

(54) Positioning cap for hinge assembly

(76) Inventor: Chien-Chen Wu, Taichung (TW)

Correspondence Address: Chien-Chen Wu, P.O. BOX 55-124, TAICHUNG, TW

(21) Appl. No.: 11/473,075

(22) Filed: Jun. 23, 2006

(30) Foreign Application Priority Data
Jul. 1, 2005 (TW) 094211159

(51) Int. Cl. E05F 1/08

(52) U.S. Cl. 16/299

(57) ABSTRACT

A positioning cap of a hinge assembly includes a bowl-shaped cap with a positioning member received therein which includes a main plate and a plurality of biasing plates extend from the main plate so as to be in contact with an inner periphery of the bowl-shaped cap. A central hole is defined through the main plate of the positioning member and a plurality of slits are radially defined in the main plate so as to form a plurality of pawls such that when a shaft extends through the central hole, the shaft is caught by the pawl plates. A plurality of draining holes are defined through the main plate so that the electrolytic solution drains therefrom.

### FIELD OF THE INVENTION

The present invention relates to a positioning cap for a hinge assembly and the cap includes pawls to position the shaft and holes for allowing electrolytic solution to escape therefrom.

### BACKGROUND OF THE INVENTION

A conventional hinge assembly is shown in FIGS. 1 and 2 and generally includes a first part 1 and a second part 2, wherein the first part 1 includes a tube 102 and a first leaf 104 and the second part 2 includes a second leaf 202 and two end plates 204 on two ends of the second leaf 202. The first leaf 104 can be fixed to a door or a window and the second leaf 202 can be fixed to a frame, the tube 102 is located between the two end plates 204 and a shaft 7 with a spring 3 mounted thereto extend through the tube 102 and the two end plates 204. A base member 4 is rested on a top surface of one of the end plates 204 at a lower end of the second leaf 202 and the shaft 7 extends through the base member 4. An adjustment cap 5 is mounted to the shaft 7 and is positioned at an underside of the other end plate 204. An adjustment pin 6 radially extends through one of adjustment holes in the adjustment cap 5. Two positioning caps 8 are respectively connected to two ends of the shaft 7 and each positioning cap 8 includes a cap 801 and a positioning member 802 which is engaged with the U-shaped cap 801. Each positioning member 802 includes a peripheral wall and a contact part 806 extending radially from the periphery wall so as to be engaged with an inner periphery of the cap 801 and position the positioning member 802. A central hole 805 is defined through the positioning member 802 and a plurality of radial slits 803 are defined around the central hole 805 so as to form pawl plates 804 between the slits 803. As shown in FIG. 2, when the shaft 7 extends through the central holes 805 of the positioning members 802, the pawl plates 804 are forced to be bent an angle and position the shaft 7, such that the shaft 7 is prevented from being pulling out from the central holes 805.

Because the positioning caps 8 are exposed in the air so that they are electro-plated with an anti-rust layer. However, during the electro-plating, the electrolytic solution might be trapped between the cap and the positioning member 802 and will corrode cap 801, the positioning member 802 and the shaft 7.

The present invention intends to provide a positioning cap that includes draining holes such that the electrolytic solution drains from the draining holes.

### SUMMARY OF THE INVENTION

The present invention relates to a positioning cap of a hinge assembly and the positioning cap comprises a cap having a plate and a peripheral wall. A positioning member is received in the cap and includes a main plate with a plurality of biasing plates extending from the main plate so as to be in contact with the inner periphery of the peripheral wall of the cap. The main plate has a central hole a plurality of slits are radially defined in the main plate so as form a plurality of pawl plates separated by the slits. The pawl plates contact a shaft extending through the central hole so as to prevent the shaft from being pulled out from the central hole.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional hinge assembly;

FIG. 2 is a cross sectional view to show the conventional hinge assembly;

FIG. 3 is a perspective view to show the positioning cap of the present invention;

FIG. 4 is an exploded view to show the positioning cap of the present invention;

FIG. 5 is a cross sectional view to show the positioning cap of the present invention;

FIG. 6 shows that the positioning cap is assembled with a hinge assembly, and FIG. 7 shows that the shaft extends through the central hole and positioned by the pawl plates.

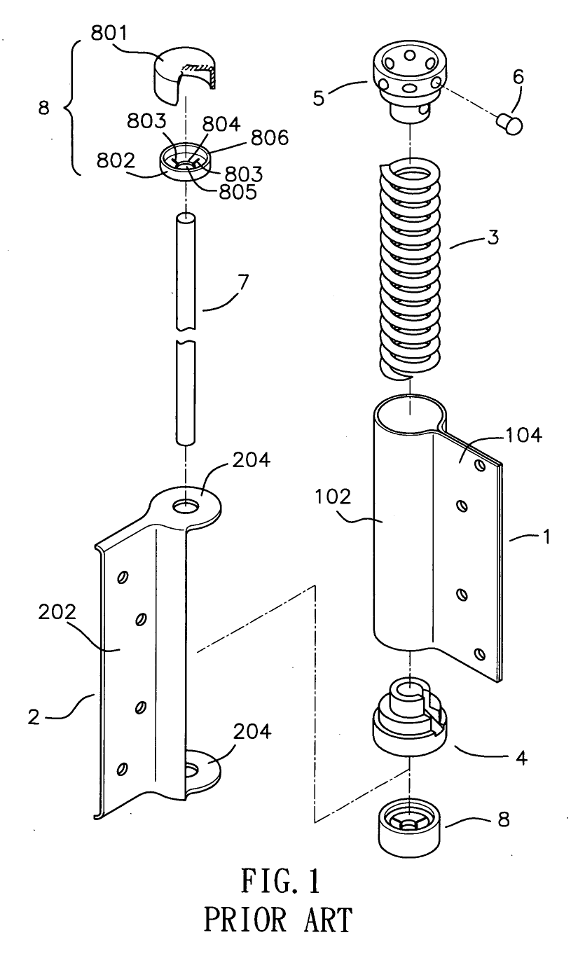

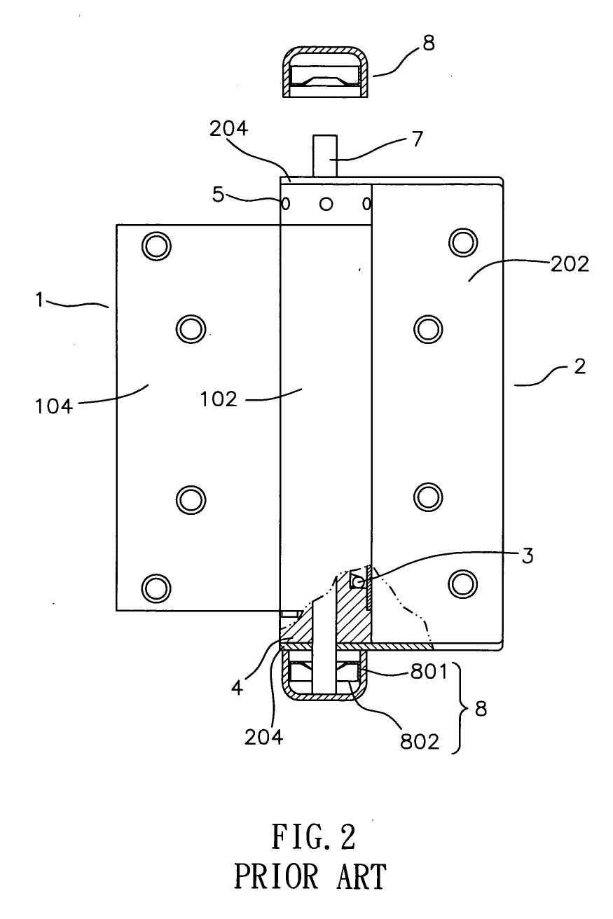

### DETAILED DESCRIPTION OF THE PREFERRED EMBODIMENT

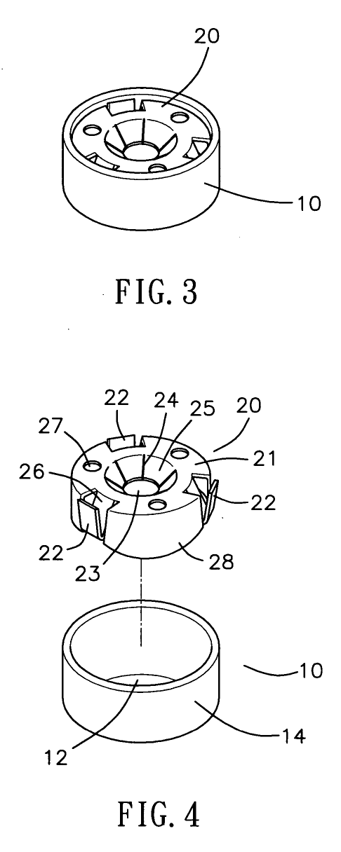

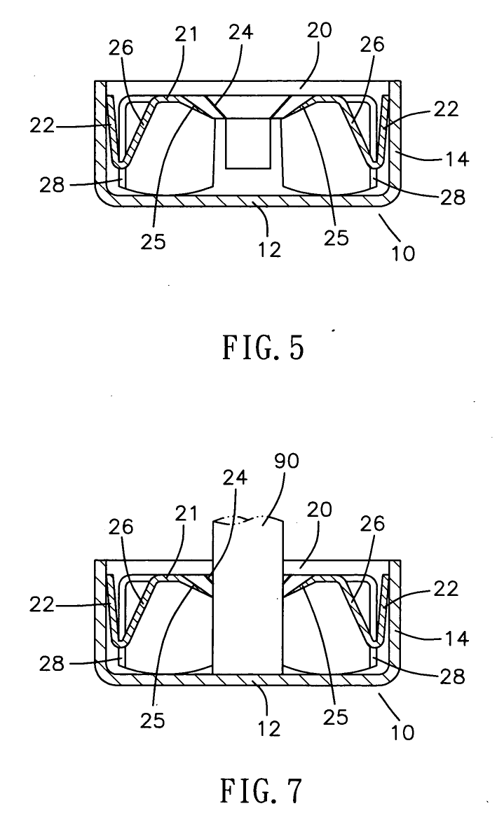

Referring to FIGS. 3 to 5, the positioning cap for a hinge assembly of the present invention comprises a bowl-shaped cap 10 having a plate 12 and a peripheral wall 14 extending from a periphery of the plate 12. A positioning member 20 is received in the cap 10 and includes a main plate 21 and a plurality of biasing plates 22 extend radially from the main plate 21. The main plate 21 includes a central hole 23 defined therethrough and a plurality of slits 24 are radially defined in the main plate 21 and communicate with the central hole 23 so as to form a plurality of pawl plates 25 separated by the slits 24. The biasing plates 22 each are connected with a connection plate 26 which is connected between the biasing plate 22 an the main plate 21. The biasing plates 22 are in contact with an inner periphery of the peripheral wall 14 of the cap 10 so as to position the positioning member 20 in the cap 10. The main plate 21 has a plurality of reinforcement plates 28 extending therefrom and located between the biasing plates 22 to reinforce the structural strength of the positioning member 20. A plurality of draining holes 27 are defined through the main plate 21 such that electrolytic solution can drain from the draining holes 27.

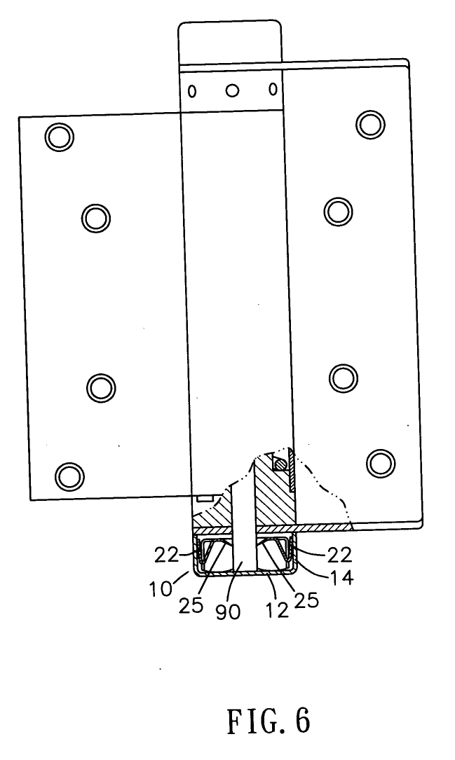

As shown in FIGS. 6 and 7, because the inner diameter of the central hole 23 is slightly smaller than the diameter of the shaft 90 so that when the positioning caps are assembled with a hinge assembly, the shaft 90 forces the pawl plates 25 to bend an angle and catch the outer periphery of the shaft 90 to avoid the shaft 90 from being pulled out from the central hole 23.

The connection plates 26 maintain the biasing force for the biasing plates 2 so that the positioning member 20 can be easily positioned in the bowl-shaped cap 10. The draining holes 27 in the main plate 21 ensure that no electrolytic solution is trapped between the cap 10 and the positioning member 20.

While we have shown and described the embodiment in accordance with the present invention, it should be clear to those skilled in the art that further embodiments may be made without departing from the scope of the present invention.

What is claimed is:

1. A positioning cap of a hinge assembly, comprising:
a cap having a plate and a peripheral wall;
a positioning member received in the cap and including a main plate and a plurality of biasing plates extending from the main plate, a central hole defined through the main plate and a plurality of slits radially defined in the main plate and communicating with the central hole, the main plate having a plurality of pawl plates separated by the slits, the biasing plates being in contact with an inner periphery of the peripheral wall of the cap.

2. The cap as claimed in claim 1, wherein the biasing plates each are connected with a connection plate which is connected between the biasing plate an the main plate.

3. The cap as claimed in claim 1, wherein the main plate has a plurality of reinforcement plates extending therefrom and located between the biasing plates.

4. The cap as claimed in claim 1, wherein a plurality of draining holes are defined through the main plate.
